(19) United States
(12) Patent Application Publication
(10) Pub. No.: US 2017/0282678 A1
(43) Pub. Date: Oct. 5, 2017

(54) AIR RETURN BULKHEAD

(71) Applicant: Signode Industrial Group LLC, Glenview, IL (US)

(72) Inventor: TOBY CLARK, Smiths, AL (US)

(21) Appl. No.: 15/088,363

(22) Filed: Apr. 1, 2016

(51) Int. Cl. B60H 1/00; B60P 3/20

(52) U.S. Cl. CPC B60H 1/00364; B60P 3/20; B60H 1/00514

(57) ABSTRACT

A new and improved air return bulkhead for a refrigeration cargo trailer is disclosed. The air return bulkhead comprises two primary components, a first upper panel component and a second lower panel component. The first upper panel component effectively defines a fluid conduit through which relatively warm return air is fluidically conducted into the refrigeration unit, while the second lower panel component comprises a structure upon which only a plurality of pallet stops are integrally formed. The second lower panel component is entirely separate from the upper panel component, and in this manner, whenever the pallet stops become damaged, only the used lower component needs to be simply detached and replaced. An upper edge portion of the first upper panel component is also provided with a blade member which will engage the rear face of the refrigeration unit along a linear locus extending across the entire horizontal extent or width of the refrigeration unit so that cooled or refrigerated air cannot effectively be sucked back into the inlet or intake portion of the refrigeration unit, thereby preventing the occurrence of “short cycling” of the refrigeration unit.

### FIELD OF THE INVENTION

The present invention relates generally to air return bulkheads for use in connection with refrigeration units disposed within refrigeration-type cargo trailers, and more particularly to a new and improved air return bulkhead which comprises a pair of substantially coplanar panel members disposed within a vertically oriented plane wherein a first lower one of the pair of substantially coplanar panel members is adapted to be fixedly connected to the front wall member of the cargo trailer and comprises a plurality of pallet stop members integrally formed thereon and disposed within a horizontally oriented array, and a second upper one of the pair of substantially coplanar panel members which is also adapted to be fixedly connected to the front wall member of the cargo trailer an which effectively defines the fluidic connection to the lower input end of the refrigeration unit so as to conduct warm return air to the refrigeration unit such that the return air can in fact be cooled and then outputted out from the upper end of the refrigeration unit for fluid flow into the cargo trailer. In this manner, if the first, lower pallet stop panel member needs to be replaced, such as, for example, if the same becomes damaged or worn over time as a result of the same being repeatedly engaged by cargo pallets as is common when multiple cargo loads are loaded into the cargo trailer, unloaded from the cargo trailer, and new loads are loaded into the cargo trailer, only the worn or damaged first, lower pallet stop panel member needs to be removed and replaced. In this manner, the entire air return bulkhead does not need to be removed from its fixed position upon the front wall member of the cargo trailer. This will significantly reduce maintenance and service time which concomitantly reduces the time that the cargo trailer will be out of service.

### BACKGROUND OF THE INVENTION

Temperature-controlled cargo containers, such as, for example, refrigerated trucking trailers, are of course well known for transporting food or other products that need to be shipped under predetermined temperature-controlled conditions. Conventionally, a refrigerated trailer usually has a refrigeration unit mounted upon an upper region of the front wall member of the trailer wherein a major portion of the refrigeration unit usually projects outwardly through the front wall member of the trailer so as to effectively be located externally of the trailer, however, relatively warm air inlet and relatively cooled air outlet portions of the refrigeration unit are fluidically connected to the interior cargo space of the refrigeration trailer so as to continuously recirculate cooled or refrigerated air throughout the interior cargo space of the refrigeration trailer. More particularly, the relatively warm air is effectively sucked into the air inlet or intake portion of the refrigeration unit from regions of the refrigeration trailer which are disposed within the vicinity of the floor of the trailer, while cooled or refrigerated air is effectively forced outwardly from the air outlet or output portion of the refrigeration unit and into those regions of the refrigerated trailer which are disposed within the vicinity of the ceiling of the refrigeration trailer. In addition, in order to facilitate or cause the cooled or refrigerated air to in fact traverse substantially the entire axial extent of the interior cargo space within the refrigerated trailer such that a substantially uniform temperature level is in fact achieved throughout the entire axial length or extent of the interior cargo space of the refrigerated trailer, axially extending ducting is provided within the vicinity of the interior ceiling surface portion of the refrigerated trailer, and suitable vents are provided at predeterminedly spaced axial locations within such ducting in order to permit the cooled refrigerated air to flow outwardly from the ducting at such predetermined axial locations along the axial extent of the refrigeration trailer. Still further, a vertically oriented air return bulkhead is operatively connected to the front wall member of the refrigeration trailer so as to substantially extend vertically between the air inlet or intake portion of the refrigeration unit and the floor region of the refrigeration trailer. The air return bulkhead effectively defines a hollow enclosure whereby, for example, peripheral portions of the air return bulkhead can be attached to the front wall member of the refrigerated trailer, however, the central portion of the air return bulkhead is effectively spaced from the front wall member of the refrigeration trailer so as to effectively define a return-air conduit, for the relative warm air, from the floor region of the refrigeration trailer to the air inlet or intake portion of the refrigeration unit. An example of such a conventional mounting of a refrigeration unit upon a front wall member of a refrigerated trailer, the use of such axially extending ducting within the internal ceiling region of the refrigerated trailer in order to conduct relatively cooled air toward the rear portion of the refrigerated trailer, and the use of the an air return bulkhead mounted upon the front wall member of the refrigerated trailer so as to effectively define a return-air conduit for conducting relatively warm air from the floor region of the refrigeration trailer to the air inlet or intake portion of the refrigeration unit, is disclosed, for example, within FIG. 1 of U.S. Pat. No. 7,351,136 which issued to Nelson et al. on Apr. 1, 2008.

Other similar air return bulkheads, which perform similar operations in connection with their respective refrigeration-type cargo trailers, are also disclosed within U.S. Pat. No. 8,298,056 which issued to Clark on Oct. 30, 2012, U.S. Pat. No. 6,945,865 which issued to Turek on Sep. 20, 2005, U.S. Pat. No. 6,827,534 which issued to Onken on Dec. 7, 2004, U.S. Pat. No. 6,626,753 which issued to Onken on Sep. 30, 2003, U.S. Pat. No. 6,203,419 which issued to Onken on Mar. 20, 2001, U.S. Pat. No. 5,993,310 which issued to Onken on Nov. 30, 1999, U.S. Pat. No. 5,807,046 which issued to Onken on Sep. 15, 1998, U.S. Pat. No. 5,947,812 which issued to Henning on Sep. 7, 1999, and U.S. Pat. No. 5,769,704 which issued to Henning on Jun. 23, 1998. While all of the aforenoted patents are operatively satisfactory, and while U.S. Pat. No. 8,298,056, which issued to Clark on Oct. 30, 2012, appears to be the closest known prior art from a structural perspective, it is noted that periodically, the pallet stops, conventionally structurally incorporated within the lowest portion of the air return bulkhead, need to be replaced because the pallet stops, as their name implies, are effectively subjected to the most structural abuse normally encountered during the frequent loading of cargo into the cargo trailer, as well as the movement of cargo within the cargo trailer, during the innumerable times that different cargo loads are in fact loaded into and/or removed from the cargo trailers. More particularly, again, as their name implies, the pallet stops effectively prevent any damage from occurring to the air return bulkhead and to the refrigeration unit operatively associated therewith by absorbing any forces that may be encountered as a result of the cargo pallets of the cargo loads being loaded into and moved within the cargo trailer, wherein such forces would otherwise damage the air return bulkhead and the refrigeration unit operatively associated therewith. Accordingly, if the pallet stops structurally incorporated upon the air return bulkheads are already damaged, crushed, flattened, or the like, they can no longer provide the required protection to the air return bulkhead and the refrigeration unit operatively associated therewith. Therefore, the pallet stops need to be replaced whereby new or refurbished pallet stops can be employed so as to in fact provide their protective services to the air return bulkhead and refrigeration unit operatively associated therewith.

As can be readily appreciated, however, from, for example, U.S. Pat. No. 8,298,056, the pallet stops or reinforcement members 124 are integrally formed as a component part of the lower panel member 102 of the air return bulkhead. Accordingly, if the pallet stops or reinforcement members 124 are damaged or otherwise inoperative for their intended purposes and therefore need to be replaced, the entire lower panel member 102 must be removed and replaced. This results in a substantial waste of materials and machining operations and manufacturing time. A need therefore exists in the art for a new and improved air return bulkhead wherein the replacement of the pallet stops will not effectively require the corresponding replacement of other primary structural components of the overall air return bulkhead.

Another operational problem often encountered with conventional air return bulkheads and the refrigeration units operatively associated therewith resides in the fact that proper sealing between air return bulkheads and the refrigeration units is not always achieved. Accordingly, leakage of cooled or refrigerated air back into the air return bulkhead often occurs which effectively “tricks” the refrigeration unit into believing that the cargo area of the cargo trailer has in fact been sufficiently cooled or refrigerated whereas in fact the cargo area of the cargo trailer has not in fact been sufficiently cooled or refrigerated. This leads to the operation of what is known in the industry as “short cycles” whereby the operative cooling or refrigeration cycle of the particular refrigeration unit is prematurely terminated, with obvious detrimental results whereby the cargo is not in fact properly refrigerated as required and desired.

### OVERALL OBJECTIVES OF THE INVENTION

The overall objectives of the present invention are to overcome the various structural and operational drawbacks characteristic of, and encountered with conventional air return bulkheads, wherein, for example, damaged or otherwise inoperative pallet stops can be quickly and readily replaced when needed without requiring the replacement of other primary structural components of the air return bulkhead, and wherein further, the components comprising the air return bulkhead can be easily and quickly assembled in such a manner that the air return bulkhead effectively establishes a seal with the refrigeration unit in such a manner that leakage of cooled or refrigerated air outputted from the refrigeration unit is not in fact quickly recycled back into the air return bulkhead resulting in the “short-cycling” of the refrigeration unit whereby the refrigeration cycle is prematurely terminated and the cargo is not properly refrigerated to the degree required.

### SUMMARY OF THE INVENTION

The foregoing and other objectives are achieved in accordance with the teachings and principles of the present invention through the provision of a new and improved air return bulkhead wherein the air return bulkhead comprises two primary components, a first upper panel component and a second lower panel component. The first upper panel component of the air return bulkhead actually comprises a substantially three-sided hollow structure which effectively defines the fluid conduit of the air return bulkhead through which the relatively warm return air is fluidically conducted upwardly toward and into the refrigeration unit so as to be cooled by the refrigeration unit and outputted as cooled or refrigerated air back into the cargo trailer. The bottom of the first upper panel component is open so as to define an air inlet for the relatively warm air to flow into the fluid conduit, and the top of the first upper panel component is likewise open so as to define an air outlet such that the relatively warm air can flow into the refrigeration unit. The second lower panel component of the air return bulkhead comprises a substantially solid structure upon which only a plurality of pallet stops are integrally formed. The second lower panel component is entirely separate from the upper panel component, although they are capable of being mated or fitted together so as to collectively form the overall air return bulkhead, and in this manner, when the pallet stops become damaged, only the used lower component needs to be simply detached from its lower disposition upon the front wall of the cargo trailer and a new lower panel component can be attached to the lower portion of the front wall of the cargo trailer so as to effectively replace the old, used, and damaged lower panel component that was previously removed. As can readily be appreciated, no other components of the air return bulkhead need to be disconnected, disassembled, detached, or removed in order to replace and exchange the damaged pallet stops disposed upon the lower component of the air return bulkhead. It is also to be noted that the upper edge portion of the first upper panel component is provided with a flap or blade member which is disposed at a predetermined angle with respect to the rear face or plane of the first upper panel component of the air return bulkhead such that the flap or blade member is oriented toward the rear face of the refrigeration unit. In this manner, when the first upper panel component of the air return bulkhead is mounted upon and mated with the refrigeration unit, the angled flap or blade member will engage the rear face of the refrigeration unit along a linear locus extending across the entire horizontal extent or width of the refrigeration unit so that cooled or refrigerated air cannot effectively be sucked back into the inlet or intake portion of the refrigeration unit. It can be appreciated that the flap or blade member therefore effectively serves as a check valve preventing reverse flow of cooled or refrigerated air back into the inlet or intake portion of the refrigeration unit thereby preventing the occurrence of “short cycling” of the refrigeration unit.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a front elevational view of the new and improved air return bulkhead constructed in accordance with the principles and teachings of the present invention;

FIG. 2 is a perspective view of the new and improved air return bulkhead as illustrated within FIG. 1;

FIG. 3 is a side elevational view of the new and improved air return bulkhead as illustrated within FIGS. 1 and 2 and particularly denoting a Detail 4 thereof;

FIG. 4 is an enlarged cross-sectional view of the new and improved air return bulkhead as illustrated within FIGS. 1-3 showing an enlarged view of the Detail 4 noted in FIG. 3;

FIG. 5 is a front elevational view of the new and improved air return bulkhead, similar to that of FIG. 1, showing, however, only the first upper panel component of the air return bulkhead;

FIG. 6 is a perspective view of the first upper panel component of the air return bulkhead as illustrated within FIG. 5;

FIG. 7 is a side elevational view of the first upper panel component of the air return bulkhead as illustrated within FIGS. 5 and 6 and particularly denoting a Detail 8 thereof;

FIG. 8 is an enlarged cross-sectional view of the first upper panel component of the air return bulkhead as illustrated within FIGS. 5-7 showing an enlarged view of the Detail 8 noted in FIG. 7;

FIG. 9 is a front elevational view of the new and improved air return bulkhead, similar to that of FIGS. 1 and 5, showing, however, only the second lower panel component of the air return bulkhead;

FIG. 10 is a perspective view of the second lower panel component of the air return bulkhead as illustrated within FIG. 9;

FIG. 11 is a side elevational view of the second lower panel component of the air return bulkhead as illustrated within FIGS. 9 and 10; and

FIG. 12 is an end elevational view of the second lower panel component of the air return bulkhead as illustrated within FIGS. 9-11.

### DETAILED DESCRIPTION OF THE PREFERRED EMBODIMENT

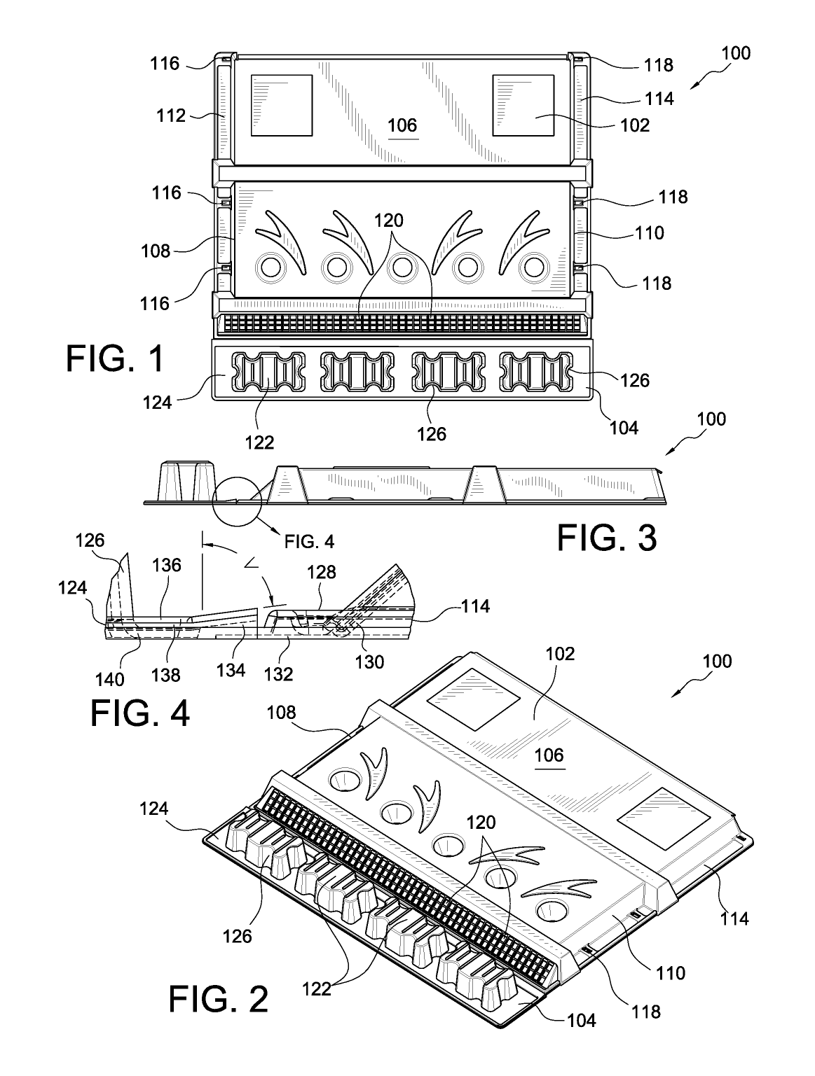

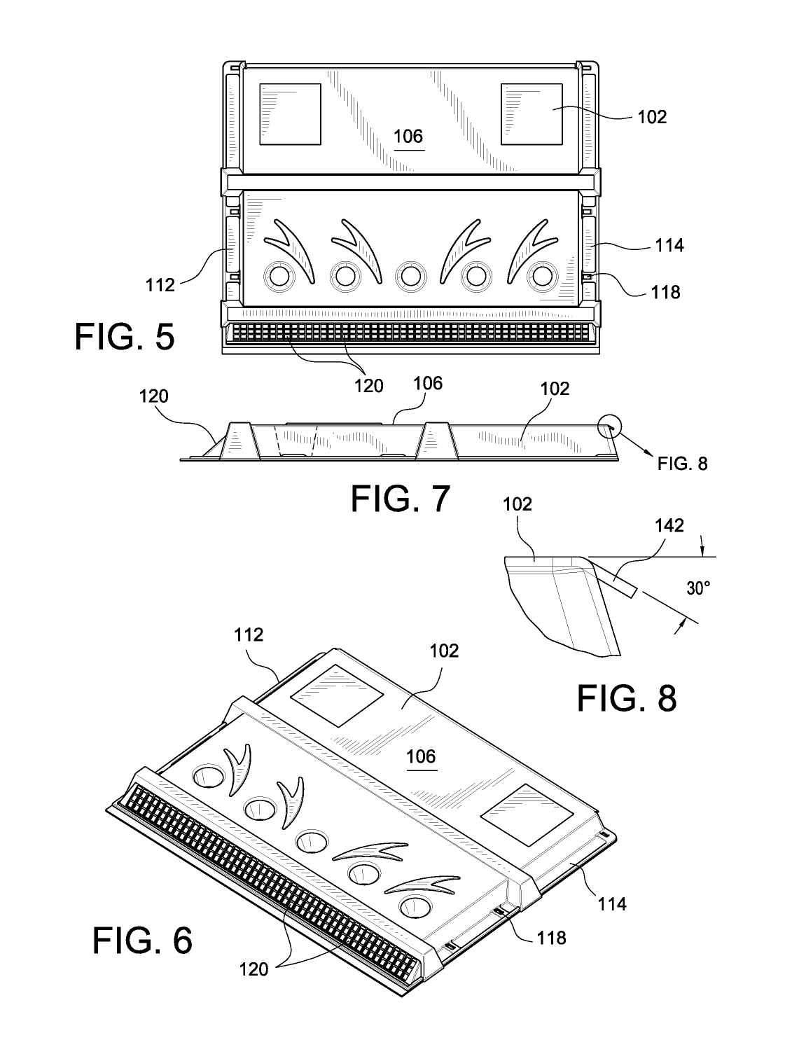

Referring now to the drawings, and more particularly to FIGS. 1-4 thereof, a new and improved vertically oriented air return bulkhead is disclosed and is generally indicated by the reference character 100. As can also be readily seen and understood from FIGS. 5-12, the vertically oriented air return bulkhead 100 is seen to comprise two primary components, a first upper panel component 102 and a second lower panel component 104. It is further appreciated that the first upper panel component 102 of the air return bulkhead 100 comprises a substantially three-sided hollow structure defined by means of a substantially planar rear wall 106, which is adapted to be disposed parallel to and spaced away from the front wall of the cargo trailer when the air return bulkhead 100 is mounted upon the front wall of the cargo trailer as will be discussed hereinafter, and a pair of oppositely disposed side walls 108,110 which are oriented substantially perpendicular to the planar rear wall 106. The forward-most edge portions of the side walls 108,110 are provided with outwardly extending flanged portions 112,114 disposed parallel to the planar rear wall 106, and the flanged portions 112,114 are respectively provided with a plurality of vertically spaced apertures 116,118 so as to permit the air return bulkhead 100 to be fixedly mounted upon the front wall of the cargo trailer by means of suitable fasteners, not shown. It is to be appreciated still further that the upper edge region of the first upper panel component 102 of the air return bulkhead 100 is open so as to structurally and fluidically mate with the refrigeration unit of the cargo trailer, while the lower edge region of the first upper panel component 102 of the air return bulkhead 100 is provided with a multitude of air inlet openings or vent holes 120 which are arranged within a rectangular grid-type array extending horizontally across the lower edge region of the first upper panel component 102. The three-sided hollow structure comprising or defining the first upper panel component of the air return bulkhead 100 effectively defines a fluid conduit for the air return bulkhead 100 through which the relatively warm return air, disposed within the vicinity of the floor region of the cargo trailer, is fluidically conducted upwardly toward and into the refrigeration unit so as to be cooled by the refrigeration unit and outputted as cooled or refrigerated air back into the cargo trailer. The multitude of air inlet openings or vent holes 120 therefore effectively define the inlet or intake portion of the first upper panel component 102 for such relatively warm return air to be conducted into and through the air return bulkhead 100.

In accordance with one unique feature characteristic of the air return bulkhead 100 of the present invention, it is seen that the second lower panel component 104 of the air return bulkhead 100 comprises a substantially solid one-piece structure upon which only a plurality of pallet stops 122 are integrally formed and disposed within a horizontal array. As can best be seen or appreciated from FIGS. 5-12, the second lower panel component 104 is entirely separate from the upper panel component 102, although the first upper and second lower components of the air return bulkhead 100 are capable of being mated or fitted together, as will be discussed hereinafter, so as to collectively form the overall air return bulkhead 100. The second lower panel component 104 is seen to comprise a planar support portion 124 which is adapted to be fixedly mounted upon the front wall of the cargo trailer by means of suitable fasteners, not shown, and the plurality of pallet stops 122 project rearwardly from the plane of the support portion 122 of the second lower panel component 104. In this manner, by incorporating only the pallet stops 122 upon the second lower panel component 104 of the air return bulkhead 100, when the pallet stops 122 become damaged, only the used or damaged second lower panel component 104 needs to be simply detached from its lower disposition upon the front wall of the cargo trailer and a new second lower panel component 104 can be attached to the lower portion of the front wall of the cargo trailer so as to effectively replace the old, used, and damaged second lower panel component that was previously removed. As can readily be appreciated still further, no other components of the air return bulkhead 100 need to be disconnected, disassembled, detached, or removed in order to replace and exchange the damaged pallet stops 122 disposed upon the second lower component 104 of the air return bulkhead 100.

As is known in the industry, the pallet stops 122 are adapted to be engaged by cargo pallets when the cargo pallets are loaded into the cargo trailer so that the cargo pallets do not damage the air return bulkhead 100 or the front wall of the cargo trailer. Accordingly, the pallet stops 122 are required to comprise structure which will exhibit inherent strength against compression and other damaging impact forces which may be impressed upon the pallet stops 122 by means of the cargo pallets, although, as has been noted, eventually the pallet stops 122 do become damaged to such an extent that they need to be replaced. Accordingly, it can be seen from FIGS. 1 and 2, that each one of the pallet stops 122 has a substantially rectangular parallelepiped structure, and that each side of the pallet stop 122 is provided with at least one undulation 126 which effectively defines at least one horizontally oriented, rearwardly extending structural rib, as considered when the air return bulkhead 100 is fixedly mounted upon the front wall of the cargo trailer. Accordingly, as is the case with other structural ribs incorporated within various structural components, these plurality of structural ribs will effectively provide the necessary strength and protective structural integrity against compression or other forces or loads which may be impressed upon or impact the pallet stops 122 as the various cargo pallets are moved into and within the cargo trailer. In particular, it is noted that each long side of each pallet stop 122 is provided with two undulations or structural ribs 126 while each short side of each pallet stop 122 is provided with one unulation or structural rib 126.

With reference continuing to be made to FIGS. 3 and 4, another unique feature characteristic of the air return bulkhead 100 of the present invention resides in the fact the first upper panel component 102 and the second lower panel component 104 have complementary structures which facilitate the mating together of the panel components 102,104 when they are installed so as to serve as the operational air return bulkhead 100. More particularly, it is seen, for example, in FIG. 4, that the planar flanged portions 112,114 of the first upper panel component 102 are fabricated so as to effectively comprise tri-layer structures comprising an uppermost or outermost layer 128, an intermediate layer 130, and a lowermost or innermost layer 132, and the intermediate layer 130 of the first upper panel component 102 is provided with a vertically downwardly extending wedge-shaped tongue 134 within the lower end region of the first upper panel component 102, as considered when the air return bulkhead 100 is installed upon the front wall of the cargo container. In a similar manner, the planar support portion 124 of the second lower panel component 104 is also fabricated as a tri-layer structure comprising an uppermost or outermost layer 136, an intermediate layer 138, and a lowermost or innermost layer 140, as can also best be seen from FIG. 4. The lowermost or innermost layer 140 of the second lower panel component 104 is adapted to component 102, while the intermediate layer 138 of the second lower panel component 104 has a height dimension which is effectively shorter than that of the lowermost or innermost layer 140 of the second lower panel component 104 as well as the height dimension of the uppermost or outermost layer 136 of the second lower panel component 104. It is also seen that the upper region of the uppermost or outermost layer 136 of the second lower panel component 104 is tilted outwardly at a predetermined angle L which may be, for example, approximately 87° as measured from the vertical. In this manner, a wedge-shaped opening is effectively defined within the upper edge portion of the second lower panel component 104 so as to accommodate the wedge-shaped tongue 134 of the first upper panel component 102. As has been noted, these complementary structures facilitate the fitting or mating together of the upper edge portion of the second lower panel component 104 with the lower edge portion of the first upper panel component 102.

With reference lastly being made to FIGS. 5-8, and particularly to FIGS. 7 and 8, a third unique feature of the present invention resides in the fact that when the air return bulkhead 100 of the present invention is installed with respect to the refrigeration unit of the cargo trailer such that the first upper panel component 102 of the air return bulkhead 100 will engage and mate with the refrigeration unit of the cargo trailer, an air seal will effectively be formed between the first upper panel component 102 of the air return bulkhead 100 and the rear or outer face of the refrigeration unit. More particularly, it is seen that the upper edge portion of the first upper panel component 102 is provided with a flexible flap or blade member 142 which is disposed at a predetermined angle, such as, for example, 30°, with respect to the rear face or plane of the first upper panel component 102 of the air return bulkhead 100 such that the flap or blade member 142 is oriented toward the rear face of the refrigeration unit. In this manner, when the first upper panel component 102 of the air return bulkhead 100 is mounted upon and mated with the refrigeration unit, the angled flap or blade member 142 will engage the rear face of the refrigeration unit along a linear locus extending across the entire horizontal extent or width of the refrigeration unit so that cooled or refrigerated air cannot effectively be sucked back into the inlet or intake portion of the refrigeration unit. It can be appreciated that the flap or blade member 142 therefore effectively serves as a check valve preventing reverse flow of cooled or refrigerated air back into the inlet or in-take portion of the refrigeration unit thereby preventing the occurrence of “short cycling” of the refrigeration unit.

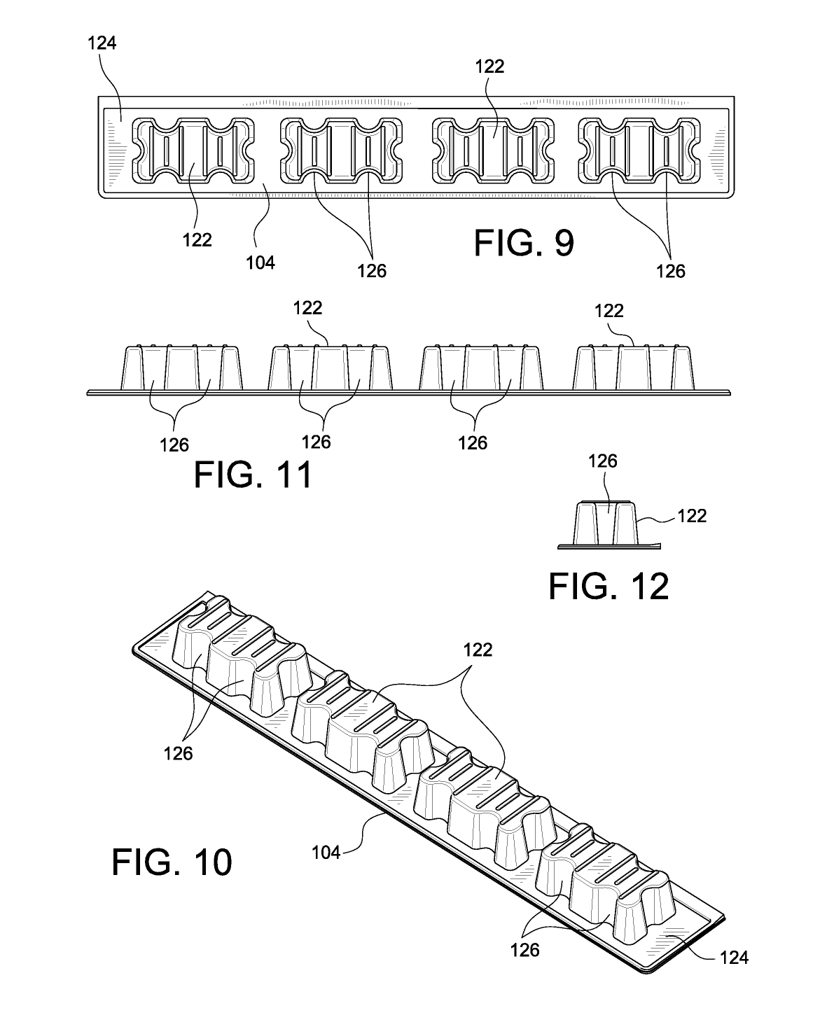

As has been previously noted, the second lower panel component 104 of the air return bulkhead 100 is a separate and distinct structural component of the air return bulkhead 100 from the first upper panel component 102 of the air return bulkhead 100. The second lower panel component 104 of the air return bulkhead 100 is illustrated more clearly within FIGS. 9-12. It is therefore to be appreciated that when the air return bulkhead 100 is to be installed within the refrigerated cargo trailer and engaged and mated with the refrigeration unit of the refrigerated cargo trailer, the second lower panel component 104 will be installed first upon the front wall of the cargo trailer and within the vicinity of the floor region of the cargo trailer. Apertures or holes, not shown but similar to the apertures or holes 116 or 118 provided within the opposite side edge flanged portions 112,114 of the first upper panel component 102, can be provided so as to permit suitable fasteners, also not shown, to fixedly secure the second lower panel component 104 to the front wall of the cargo trailer. Subsequently, the first upper panel component 102 is installed by initially inserting the wedge-shaped tongue 134 of the first upper panel component 102 into the wedge-shaped opening of the second lower panel component 104, and then effectively pivoting the first upper panel component 102 toward the refrigeration unit such that the opposite side flanged portions 112,114 of the first upper panel component 102 will engage the front wall of the cargo trailer while the blade member 142, disposed upon the upper edge portion of the first upper panel component 102, will engage the rear surface of the refrigeration unit so as to effectively form a seal with the rear surface of the refrigeration unit along a linear locus extending substantially the entire width of the refrigeration unit. Suitable fasteners may then be inserted into the holes or apertures 116,118 of the first upper panel component 102 so as to in fact fixedly secure the first upper panel component to the front wall of the cargo trailer.

It is therefore to be appreciated that as a result of the provision of the blade member 142 on the upper edge portion of the first upper panel component 102, the aforenoted seal between the first upper panel component 102 and the rear surface portion of the refrigeration unit has been established which will effectively prevent any cooled or refrigerated air, outputted from the refrigeration unit, being sucked back into the intake or inlet portion of the refrigeration unit. This advantageously prevents the refrigeration unit from being “tricked” into thinking that the return air is sufficiently cooled whereby the refrigeration unit will effectively be prematurely cycled OFF, which is known in the industry as “short cycling”. Still further, it can be appreciated that when the pallet stops 122 become damaged, only the second lower panel component 104 needs to be removed and replaced with a new second lower panel component 104 with new pallet stops 122 thereon. In addition, the removal of the second lower panel component 104 does not interfere with any of the other components or structures of the air return bulkhead 100, and conversely, no other components or structures of the air return bulkhead 100 need to be removed, detached, disassembled, or the like, in order to facilitate the removal and replacement of the second lower panel component 104 with the pallet stops 122 integrally formed thereon.

Obviously, many variations and modifications of the present invention are possible in light of the above teachings. It is therefore to be understood that within the scope of the appended claims, the present invention may be practiced otherwise than as specifically described herein.

### REFERENCE NUMBER KEY

100—Air return bulkhead
102—First upper panel member of air return bulkhead
104—Second lower panel member of air return bulkhead
106—Rear planar wall of first upper panel member 102
108—Left side wall of first upper panel member 102
110—Right side wall of first upper panel member 102
112—Left flanged portion of first upper panel member 102
114—Right flanged portion of first upper panel member 102
116—Apertures within left flanged portion 112
118—Apertures within right flanged portion 114
120—Air vents within lower region of first upper panel component
122—Pallet stops disposed upon second lower panel component
124—Planar support portion of second lower panel component
126—Structural ribs of pallet stops 122
128—Upper layer of flanged portion 114
130—Intermediate/middle layer of flanged portion 114
132—Lower layer of flanged portion 114
134—Tongue of intermediate/middle layer 130 of flanged portion 114
136—Upper layer of planar support portion 124 of second lower panel component
138—Intermediate/middle layer of second lower panel component
140—Lower layer of second lower panel component
142—Blade member first upper panel component 102

1-11. (canceled)

12. An air return bulkhead comprising:
a first panel component comprising a first end and an at least partially open second end, the first panel component defining a fluid conduit between the first and second ends, the first end defining an air inlet opening in fluid communication with the fluid conduit; and
a second panel component comprising a pallet stop, the second panel component configured to removably attach to the first panel component.

13. The air return bulkhead of claim 12, wherein the first panel component further comprises a first side wall, a second side wall spaced apart from the first side wall, and a rear wall between the first and second side walls, wherein the first and second side walls and the rear wall at least partially define the fluid conduit.

14. The air return bulkhead of claim 13, wherein the first panel component further comprises a first flanged portion extending from the first side wall and a second flanged portion extending from the second side wall, wherein the first and second flanged portions each define multiple fastener-receiving openings.

15. The air return bulkhead of claim 14, wherein the first end of the first panel component comprises a mating tongue and the second panel component defines a mating opening sized and shaped to receive the mating tongue to removably attach the second panel component to the first panel component.

16. The air return bulkhead of claim 15, wherein the second panel component comprises a first end and a second end and the mating opening is defined in the second end.

17. The air return bulkhead of claim 12, wherein the second panel component further comprises a planar support portion from which the pallet stop extends.

18. The air return bulkhead of claim 17, wherein the support portion defines multiple fastener-receiving openings.

19. The air return bulkhead of claim 12, wherein the second panel component comprises multiple spaced-apart pallet stops.

20. The air return bulkhead of claim 12, wherein the first end of the first panel component comprises a mating tongue and the second panel component defines a mating opening sized and shaped to receive the mating tongue to removably attach the second panel component to the first panel component.

21. The air return bulkhead of claim 20, wherein the second panel component comprises a first end and a second end and the mating opening is defined in the second end.

22. The air return bulkhead of claim 21, wherein the mating opening is wedge shaped.

23. The air return bulkhead of claim 22, wherein the second end of the first panel component comprises a flexible sealing flap.

24. An air return bulkhead comprising:
a first panel component comprising a first end and an at least partially open second end, the first panel component defining a fluid conduit between the first and second ends, the first end defining an air inlet opening in fluid communication with the fluid conduit; and
a second panel component comprising a planar support portion having a first end and a second end and multiple pallet stops extending from the planar support portion, the second panel component configured to removably attach to the first panel component.

25. The air return bulkhead of claim 24, wherein the first end of the first panel component comprises a mating tongue and the second end of the second panel component defines a mating opening sized and shaped to receive the mating tongue to removably attach the second panel component to the first panel component.

26. A panel component for an air return bulkhead, the panel component comprising:
a planar support portion having a first end and a second end and configured to removably attach to another panel component of the air return bulkhead; and
multiple pallet stops extending from the planar support portion.

27. The panel component of claim 26, wherein the second end of the planar support portion defines a mating opening sized and shaped to receive a mating tongue of the first panel component to removably attach to the other panel component.

28. The panel component of claim 27, wherein the mating opening is wedge shaped.

29. The panel component of claim 28, wherein the pallet stops are spaced apart.

30. The panel component of claim 29, wherein each pallet stop comprises an integral structural rib.

31. The panel component of claim 30, wherein the planar support portion defines multiple fastener-receiving openings.
